(19) United States
(12) Patent Application Publication
(10) Pub. No.: US 2024/0142594 A1
(43) Pub. Date: May 2, 2024

(54) Unknown

(71) Applicant: SICK AG, Waldkirch (DE)

(72) Inventor: Hans-Jürgen KAMMER, Sexau (DE)

(21) Appl. No.: 18/383,593

(22) Filed: Oct. 25, 2023

(30) Foreign Application Priority Data
Oct. 28, 2022 (DE) 102022128703.3

(51) Int. Cl. G01S 13/08; G01S 13/88

(52) U.S. Cl. CPC G01S 13/08; G01S 13/88

(57) ABSTRACT

The invention relates to a method for operating a position measurement apparatus, wherein the method comprises: a measurement signal being received from the position measurement apparatus; a measurement noise signal being estimated based on the measurement signal; a first variance estimation and a second variance estimation different from the first variance estimation being performed based on the measurement noise signal, wherein the first variance estimation yields a first variance estimated value and the second variance estimation yields a second variance estimated value; a final variance estimated value being determined based on a comparison of the first variance estimated value with the second variance estimated value; and a confidence interval being determined based on the final variance estimated value, wherein the confidence interval is output and is preferably used in a safety function.

The invention relates to a method for operating a position measurement apparatus and to a corresponding position measurement apparatus.

Position measurement apparatus, such as distance measurement sensors, are used in many fields such as in robotics or in industrial manufacturing processes. In many of the mentioned application areas, and in particular in object localization for use in industrial safety technology, the precision and reliability of the measurement in particular play a decisive role. For example, the distances detected by the distance measurement apparatus in a manufacturing plant must be determined with sufficient reliability to ensure, for example, the safety of workers who are working on the machine.

For e.g. safe position measurement apparatus, corresponding safety functions are used when using the position measurement apparatus, wherein confidence intervals are usually determined in which e.g. the true distance value lies with a sufficiently high probability. However, the determination of such confidence intervals is often inaccurate and not adapted to sudden changes in the measurement process. Furthermore, the confidence intervals are usually predefined before the operation of a corresponding sensor so that no subsequent adjustments are possible.

Thus, it is an underlying object of the invention to provide an improved method for operating a position measurement apparatus and a corresponding position measurement apparatus.

This object is satisfied by a method according to claim 1 and by a position measurement apparatus according to claim 15.

The invention relates to a method for operating a position measurement apparatus, wherein the method comprises:
a measurement signal being received from the position measurement apparatus;
a measurement noise signal being estimated based on the measurement signal;
a first variance estimation and a second variance estimation different from the first variance estimation being performed based on the measurement noise signal,
wherein the first variance estimation yields a first variance estimated value and the second variance estimation yields a second variance estimated value;
a final variance estimated value being determined based on a comparison of the first variance estimated value with the second variance estimated value; and
a confidence interval being determined based on the final variance estimated value, wherein the confidence interval is output and is preferably used in a safety function.

The position measurement apparatus can in particular be an apparatus for the distance measurement and/or direction measurement of an object to be detected. Accordingly, the measurement signal can comprise one or more distance values and/or one or more direction values. The distance and/or direction measurement can, for example, take place optically, e.g. by means of a laser scanner. Alternatively or additionally, sound sensors or radio sensors (i.e. wave-based sensors/RADAR) can also be used in the position measurement apparatus. Radio sensors for UWB (“Ultra Wide Band”) technology can in particular be used in the position measurement apparatus, for example, to detect radio transponders at objects. In particular if the position measurement apparatus is to be configured as a safe position measurement apparatus, it can be necessary to know the above-mentioned confidence interval and in particular to use it in the safety function.

In other words, the confidence interval, i.e. a range in which an actual distance value that is measured lies with a certain probability, is therefore determined based on a comparison of at least two variance estimated values.

Since a reliability of the measurement in particular depends on the measurement noise, a measurement noise signal is first determined based on the received measurement signal. This step can also be designated as preconditioning. For example, the measurement noise signal can be extracted from the measurement signal by means of a filter or other methods, wherein the useful signal of the measurement signal can in particular be considered. Furthermore, the measurement signal, for example, represents a continuous or discrete time sequence of a plurality of measurement values. The measurement signal thus represents the time development of the acquired measurement values, wherein the last measurement value of the measurement signal, for example, represents the current or the last acquired measurement value.

Based on the measurement noise signal, a first and a second variance estimation are then performed, with the two variance estimations in particular yielding different variance estimated values. For example, the first and second variance estimation are performed based on different observation windows or observation periods, wherein an observation period is in particular set to a predefined time and/or a predetermined number of measurement values. The observation period can furthermore, for example, be a retrospective observation window that, starting from the current point in time, considers a predefined period up to the current point in time. For example, with an observation period of 5 seconds, the last 5 seconds of the measurement signal or the measurement noise signal can be considered. For example, different time windows of the measurement noise signal are considered when determining the first variance estimated value and the second variance estimated value so that the first variance estimated value can differ from the second variance estimated value.

The final variance estimated value is determined by means of a comparison of the first variance estimated value with the second variance estimated value. The determination of the final variance estimated value can, for example, take place based on predefined rules and/or a mathematical function. Any determination of the final variance estimated value is generally possible that is based on a comparison of at least two variance estimated values. The final variance estimated value is then used to determine the confidence interval. The confidence interval, and in particular the size of the confidence interval, is thus not defined in advance, but is defined in dependence on the final variance estimated value.

For example, the confidence interval can be defined by the measurement value and the final variance estimated value in that a lower limit of the confidence interval can be defined as Xₘₑₐₛᵤᵣₑ−a*σ_{end} and an upper limit of the confidence interval can be defined as Xₘₑₐₛᵤᵣₑ+a*σ_{end}, where σ_{end} represents the square root of the final variance estimated value and Xₘₑₐₛᵤᵣₑ can be a current measurement value, an average measurement value or another measured value. a can be a factor that is in particular between 1 and 10, preferably between 1 and 3 (the limit values are included in each case), as also explained below.

According to the invention, two variance estimated values are thus determined by two different variance estimations and compared to one another to determine the final variance estimated value that is used for determining the confidence interval.

An advantage of the invention is that the reliability of the measurement is increased since the determination of the confidence interval takes place adaptively and not statically. A confidence interval suitable for a corresponding measurement signal is hereby determined. On the one hand, the safety of the overall system is thereby increased since unforeseen disturbances or events are, for example, reflected in at least one of the two variance estimated values and thus in the confidence interval. On the other hand, the availability of the system is increased since the system does not have to switch to a safety state due to, for example, previously required safety margins that had to be added to the statistical component of the measurement uncertainty. Rather, an operation of a corresponding system under safe conditions is ensured by the adaptive adjustment of the confidence interval.

A further advantage of the invention is that, according to the invention, the confidence interval is determined based on pure measurement data so that additional information such as signal strength, signal-to-noise ratio, etc. is not necessary.

It is understood that for different values in the measurement signal (e.g. for direction and distance values), separate confidence intervals can be determined in each case in accordance with the manner explained herein.

Further embodiments of the invention can be seen from the description, from the dependent claims, and from the drawings.

According to a first embodiment, the final variance estimated value is set to the first variance estimated value or the second variance estimated value, in particular to the one of the first or the second variance estimated value that is larger in amount. It can hereby be ensured that the final variance estimated value is always set to the larger of the two variance estimated values, whereby an underestimation of the variance is prevented. Accordingly, the confidence interval can be determined reliably, whereby the safety of the system is further increased.

According to a further embodiment, the first variance estimation takes place based on a plurality of samples of the measurement noise signal, wherein fewer samples are used for the first variance estimation than for the second variance estimation.

In particular, starting from the current point in time, the last N values of the measurement noise signal are sampled, wherein the number N can differ for the first variance estimation and for the second variance estimation. Accordingly, the first variance estimation, for example, represents a shorter observation period so that sudden changes in the measurement process, e.g. due to shadowing of radio signals or the influence of extraneous light in optical systems, are detected and considered, while the second variance estimation, on the other hand, represents a longer observation period compared to the first variance estimation so that a general trend in the variance is considered and drastic drops in the variance are prevented. The estimation of the variance based on different observation periods, i.e. based on a different number of samples of the measurement noise signal, has the advantage of ensuring a fast response time to sudden changes or a short settling time so that the use of the method is in particular suitable for use in safety applications.

According to a further embodiment, the first variance estimation takes place based on fewer than 20, fewer than 10, or fewer than 5 samples of the measurement noise signal.

As already described above, a correspondingly short observation period is hereby ensured to identify short-term large jumps in variance. The number of samples can, for example, be predetermined, in particular specific to the application. Additionally or alternatively, the number of samples for the first variance estimation can also be determined relative to the number of samples for the second variance estimation such that the number of the values to be sampled of the first and second variance estimation is, for example, in a predetermined ratio to one another, e.g. 1:3, 1:5, or 1:10.

According to a further embodiment, the second variance estimation takes place based on more than 20, 50 or 100 samples of the measurement noise signal.

As already described above, a correspondingly long observation period is hereby ensured to identify the general trend of the variance. Furthermore, the final variance estimation is prevented from being subject to strong fluctuations that can result from the first variance estimation that is based on a short observation period.

According to a further embodiment, the final variance estimated value is set to the highest value of the N last samples of the measurement noise signal. In particular, an underestimation of the variance is hereby also prevented. Furthermore, it can be ensured that strong fluctuations of the measurement noise signal or of the variance estimation, as can for example occur with the first variance estimation, are counteracted. N can, for example, comprise more than 5, 10, 20 or 50 samples. In particular, N can be determined based on the number of samples for the first and/or second variance estimation and/or on the first and/or second variance estimated value.

According to a further embodiment, the confidence interval and/or the final variance estimated value is/are further limited based on a process model. For example, the process model can include information about a process that is related to the position measurement. For example, a distance and/or a direction of the position measurement apparatus from an object, in particular a moving object, can be measured, wherein, based on the kinematic properties of the object, the estimated variance value, i.e. the final variance estimated value, and/or the confidence interval can be limited. This is particularly advantageous for non-static measurements. The information about the process model can further, for example, be defined by a user or can already be known.

According to a further embodiment, the final variance estimated value is determined based on a plausibility check, wherein the plausibility check comprises that the final variance estimated value is first set to the second variance estimated value, wherein when it is determined that the current value of the measurement noise signal is greater than a threshold value, the first variance estimated value is compared to the second variance estimated value, and wherein when it is determined that the first variance estimated value is larger in amount than the second variance estimated value, the final variance estimated value is set to the first variance estimated value. The threshold value with which the measurement noise signal is compared can in particular be a multiple (e.g. 1.5, 2 or 3 times) of the second variance estimated value.

Accordingly, the variance can generally be estimated with the second variance estimation, i.e. the final variance estimated value is set to the second variance estimated value so that the variance is estimated based on a long observation period. If the current value of the measurement noise signal deviates greatly from the estimated distribution, it can then be assumed that it is unlikely that the currently or last estimated variance value, i.e. the final variance estimated value, is still valid. To react quickly to a possible increase in the variance, the final variance estimated value is thus set to the first variance estimated value from the first variance estimation (with a short observation period)—but only under the condition that the first variance estimated value is greater than the second variance estimated value.

According to a further embodiment, the threshold value is determined depending on the final variance estimation, in particular wherein the predefined threshold value is set to a multiple of the square root of the final variance estimated value. Thus, the threshold value can correspond to a multiple of the standard deviation of the measurement signal. If it is therefore determined that the current value of the measurement noise signal is greater than the threshold value ε=α·σ, where α represents any factor, e.g. 1, 1.5, 2, or 3, and a represents the standard deviation of the measurement signal or the square root of the final variance estimated value, a comparison between the first and second variance estimated value can be initiated, with the larger value of the first and second variance estimated value being set as the final variance estimated value. This has the advantage that basically the general trend of the variance is used as a basis for the variance estimation and the first variance estimation, and thus potentially higher variance estimated values, are only considered for great deviations that, for example, represent a safety risk for a corresponding application.

According to a further embodiment, the final variance estimated value is determined based on a weighting of the first and second variance estimated value, wherein the weighting is determined in dependence on which of the first and second variance estimated value is larger in amount. A particular advantage of this embodiment is that both the general trend of the variance and rapid changes in the variance, which are, for example, caused by sudden events, are included in the variance estimation. Thus, an improved variance estimation can be achieved. For example, the final variance estimated value can be determined based on an addition of the weighted first and second variance estimated value, where:

X_{final}=b·X₁+(1−b)·X₂ (1)

where X_{final} is the final variance estimated value, b is a weighting factor, e.g. between 0 and 1, X₁ is the first variance estimated value, and X₂ is the second variance estimated value. The final variance estimated value can generally be calculated based on any desired function that has the first and second variance estimated values as input values.

According to a further embodiment, the estimation of the measurement noise signal comprises estimating a useful signal associated with the measurement signal and determining the estimated measurement noise signal based on the measurement signal and the estimated useful signal. In particular, the measurement noise signal is extracted from the measurement signal by subtracting the estimated useful signal from the measurement signal. It is generally also possible that a first measurement noise signal and a second measurement noise signal are estimated based on different observation periods of the measurement signal that in particular correspond to the first and second variance estimation. For example, the first measurement noise signal can then be used as the basis for the first variance estimation and the second measurement noise signal can be used as the basis for the second variance estimation.

According to a further embodiment, the useful signal is estimated based on a polynomial regression and/or based on a prediction filter. For example, for short observation periods, the useful signal can be estimated based on a current trend of the measurement signal. The useful signal can, for example, be determined or estimated by means of a linear or polynomial regression. Furthermore, the useful signal can be estimated by means of a prediction filter for more complex developments of the measurement signal and/or for longer observation periods. For example, the useful signal is estimated by means of at least one of the following filters: MA filter (moving average filter), AR filter (autoregressive filter) or Kalman filter. The useful signal can generally be estimated with any suitable filter or method.

According to a further embodiment, the first variance estimation is performed using a nonlinear FIR filter (finite impulse response filter). The nonlinear FIR filter can, for example, be implemented by means of a sliding time window that corresponds to a predetermined observation period. For example, the first variance estimated value at a point in time i can be calculated by the following equation:

$${X}_{1} ( i ) = \frac{1}{N - 1} {\sum }_{k = i - N + 1}^{i} {x ( k )}^{2} \qquad ( 2 )$$

where i is the index of the value of the measurement noise signal, x(k) is the value of the measurement noise signal at a point in time k, N is the number of values of the measurement noise signal per time window, and X₁(i) is the first variance estimated value that is estimated at a point in time i.

According to a further embodiment, the second variance estimation is performed using a recursive filter. For example, the second variance estimation can take place by means of a recursive calculation with exponential memory, wherein, for example, values of the measurement noise signal that are closer to the current value of the measurement noise signal are weighted more heavily in the variance estimation (also called exponential moving variance). The second variance estimated value can, for example, be calculated as follows:

X₂(i)=c·x(i)²+(1−c)·X₂(i−1) (3)

where i is the index or point in time of the value of the measurement noise signal, x(i) is the value of the measurement noise signal at a point in time i, X₂(i) is the second variance estimated value that is estimated at a point in time i, X₂(i−1) is the second variance estimated value that is estimated at a point in time i−1, and c is a smoothing coefficient for setting the memory depth.

It is an advantage of this calculation of the first and/or second variance estimated value that the calculation of the first variance estimation and/or the second variance estimation, and thus the determination of the final variance estimated value or the confidence interval, takes place comparatively efficiently, i.e. with few computing operations, so that computing power is saved. The calculation of the first and/or second variance estimated value is generally possible in any way. For example, it is also possible that the calculation options mentioned for the first variance estimation are used for the calculation of the second variance estimated value and vice versa, wherein the memory depth can be adapted or set in each case.

A further subject of the invention is a position measurement apparatus, in particular for controlling an industrial process, comprising:
a sensor for generating a measurement signal; and
an estimation module that is configured:
to estimate a measurement noise signal based on the measurement signal;
to perform a first variance estimation and a second variance estimation different from the first variance estimation based on the measurement noise signal, wherein the first variance estimation yields a first variance estimated value and the second variance estimation yields a second variance estimated value;
to determine a final variance estimated value based on a comparison of the first variance estimated value with the second variance estimated value; and
to determine a confidence interval based on the final variance estimated value,
wherein the confidence interval is output by the estimation module and is preferably used in a safety function and/or to control the industrial process.

The position measurement apparatus can, for example, be part of a control, wherein the operating state of the control can be changed based on the confidence interval.

The position measurement apparatus can be a safe position measurement apparatus, for example according to SIL 2 or SIL 3 (SIL for Safety Integrity Level). In particular in a safety-critical environment, the confidence interval output can be used for a safety function. For example, it is possible to stop a process or to stop a vehicle if the confidence interval reveals that a position of the detected object could e.g. lie in a safety range (i.e. if the confidence interval extends into the safety range), even though the current specific measurement value of the measurement signal indicates a position outside the safety range.

Likewise, it is possible for the control to operate in a normal mode as long as the determined confidence intervals and in particular the size of the determined confidence intervals do not exceed a predefined value, i.e. a measurement value corresponds with a high probability to the actual distance measurement value or deviates only slightly therefrom. Furthermore, the control can switch to a safe state, for example, by executing only a basic function or by switching off the control when the position measurement apparatus determines confidence intervals whose magnitude, for example, exceeds a predefined value. This can, for example, indicate that the reliability of the measurement is not guaranteed with sufficient certainty. Due to the adaptive adjustment of the confidence intervals, a high availability of the control with an increased or at least constant safety can be ensured since the confidence intervals can be determined adaptively and safety margins do not have to be added in advance to the statistical component of the measurement uncertainty.

The position measurement apparatus can, for example, comprise a radio location device, in particular for UWB (Ultra Wide Band). The radio location device can transmit radio signals with a bandwidth of >500 MHz and can detect radio signals sent back from an object to be detected (e.g. a transponder). A distance measurement (in particular via a transit time measurement of the radio signals) and a direction measurement can take place based on the sent-back radio signals.

Alternatively or additionally, the position measurement apparatus can also comprise an optical distance measurement apparatus and/or a laser scanner that transmits/transmit optical signals successively in different spatial directions and, based on reflected signals, determines the direction and/or distance from objects to be detected. The values for the direction and/or the distance can then form the measurement signal.

The statements regarding the method according to the invention apply accordingly to the position measurement apparatus; this in particular applies with respect to advantages and embodiments (and vice versa).

Furthermore, unless otherwise indicated, any combination of the preceding embodiments is possible.

The invention will be presented purely by way of example with reference to the drawings in the following. There are shown:

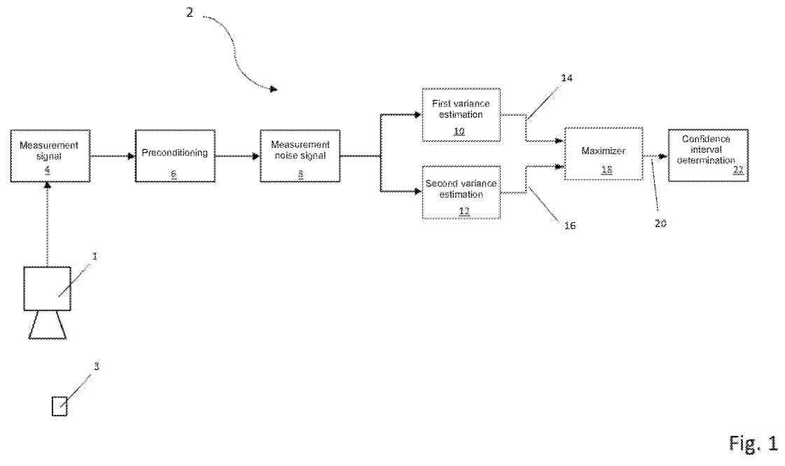

FIG. 1 a block diagram for illustrating a method for providing a safety function for a position measurement apparatus;

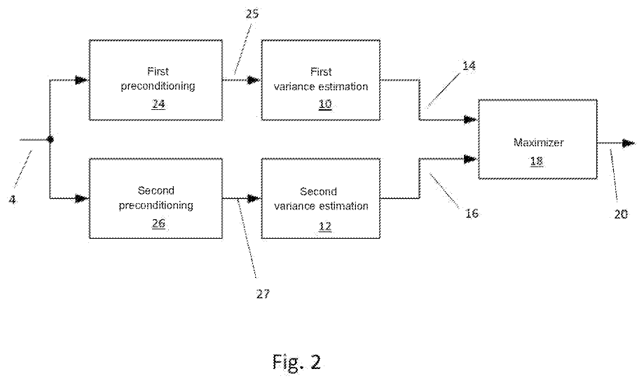

FIG. 2 a block diagram for illustrating an embodiment with a maximizer;

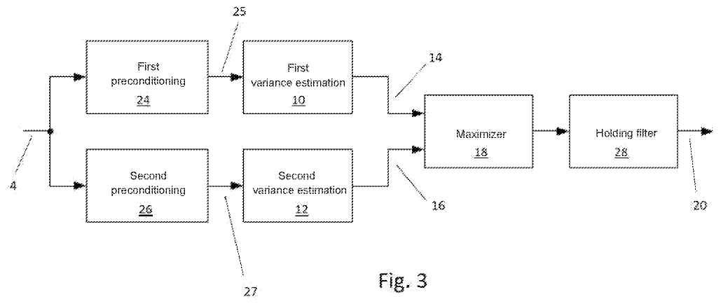

FIG. 3 a block diagram for illustrating an embodiment with a holding filter;

and

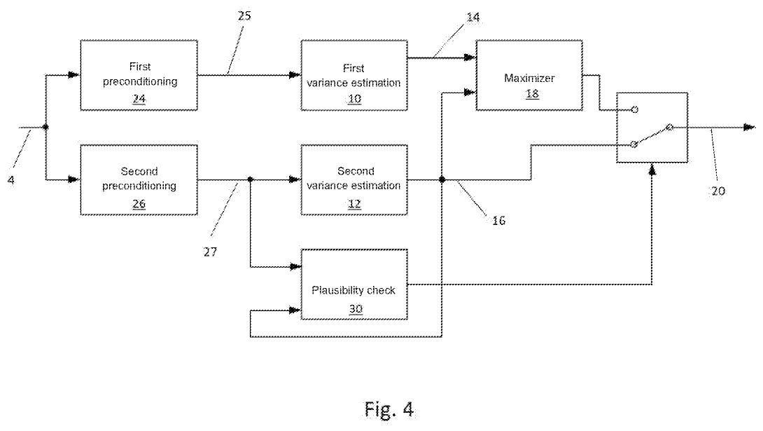

FIG. 4 a block diagram for illustrating an embodiment with a plausibility check.

FIG. 1 shows a block diagram for illustrating a method 2 for operating a position measurement apparatus 1, wherein the method comprises providing a safety function for the position measurement apparatus 1.

FIG. 1 shows the position measurement apparatus 1 and an object 3, wherein the position measurement apparatus 1 in particular measures distance values from the object 3. These distance values are processed into a measurement signal 4.

According to FIG. 1, based on the measurement signal 4 that is generated by the position measurement apparatus 1 and comprises a plurality of measurement values over a predetermined time period, a measurement noise signal 8 is extracted from the measurement signal 4 by means of a preconditioning 6, wherein the measurement noise signal 8 represents the measurement noise associated with the measurement signal 4. The preconditioning 6 in this respect comprises estimating a useful signal based on the measurement signal 4 and subtracting the estimated useful signal from the measurement signal 4 to obtain the measurement noise signal 8. In the present case, the useful signal is estimated by means of a prediction filter, for example.

Based on the measurement noise signal 8, a first variance estimation 10 and a second variance estimation 12 are performed, with the first variance estimation 10 providing a first variance estimated value 14 and the second variance estimation 12 providing a second variance estimated value 16. The first variance estimation 10 is performed based on the last five values of the measurement noise signal by means of an FIR filter to obtain the first variance estimated value 14. The second variance estimation 12, on the other hand, is performed based on the last 50 values of the measurement noise signal using a recursive filter to obtain the second variance estimated value 16. Thus, the first variance estimation 10 is based on a short observation period so that rapid, sudden changes in the measurement noise signal 8 are detected, while the second variance estimation 12 is based on a long observation period so that the overall trend of the measurement noise signal 8 is reflected in the second variance estimated value 16.

The first variance estimated value 14 and the second variance estimated value 16 are then compared with one another in a maximizer 18, wherein the maximizer 18 outputs the greater of the first and second variance estimated values 14, 16 as the final variance estimated value 20. It is hereby ensured that the variance value is not underestimated and, in case of doubt, overestimated. Thus, a more precise estimation of the variance is partly omitted to increase certainty. Based on the final variance estimated value 20, the confidence interval in which the actual position value, which here is, for example, a distance value, lies with a sufficiently high probability is finally determined in a confidence interval determination 22. For example, the confidence interval is determined based on a square root of the final variance estimated value 20 in that the confidence interval is defined by a lower limit U=D−\sqrt{X_{final}} and an upper limit U=D+\sqrt{X_{final}} where D is the current distance measurement value and X_{final} is the final variance estimated value 20.

An embodiment of a method according to the invention is shown in FIG. 2 in which, in a comparison with the embodiment of FIG. 1, a first preconditioning 24 associated with the first variance estimation 10 and a second preconditioning 26 associated with the second variance estimation 12 are performed, wherein the first preconditioning 24 resulted in a first measurement noise signal 25 and the second preconditioning 26 resulted in a second measurement noise signal 27. The first preconditioning 24 and the first variance estimation 10 are further performed based on the same observation period. The same accordingly also applies to the second preconditioning 26 and the second variance estimation 12. Thus, both the preprocessing of the measurement signal 4 and the subsequent estimation of the first and/or second variance estimated value 14, 16 are adapted to a specific observation period.

FIG. 3 shows an embodiment of a method according to the invention in which a (maximum) holding filter 28 is used that ensures that the final variance estimated value 20 is set to or kept at the highest value of the 5 last values output by the maximizer 18. This additional safety function has the effect of further reducing the risk of underestimating the variance value and stabilizing the output final variance estimated value 20.

According to a further embodiment of the method according to the invention shown in FIG. 4, the final variance estimated value 20 is determined by means of an additional plausibility check 30. According to this embodiment, the final variance estimated value 20 is set in advance to the second variance estimated value 16. When it is determined that a current value of the measurement noise signal 8, i.e. more specifically the value 27 after the second preconditioning 26, is greater than a predefined threshold value E, the first variance estimated value 14 is compared to the second variance estimated value 16 and when it is determined that the first variance estimated value 14 is larger in amount than the second variance estimated value 16, the final variance estimated value 20 is set to the first variance estimated value 14. The predefined threshold value ε is in this respect defined by way of example by the equation ε=2·σ, where σ is the square root of the second variance estimated value 16. The threshold value can generally also be calculated by another equation.

### REFERENCE NUMERAL LIST

1 position measurement apparatus
2 method
3 object
4 measurement signal
6 preconditioning
8 measurement noise signal
10 first variance estimation
12 second variance estimation
14 first variance estimated value
16 second variance estimated value
18 maximizer
20 final variance estimated value
22 confidence interval determination
24 first preconditioning
25 first measurement noise signal
26 second preconditioning
27 second measurement noise signal
28 holding filter
30 plausibility check

What is claimed is:

1-15. (canceled)

16. A method for operating a position measurement apparatus, wherein the method comprises:
a measurement signal being received from the position measurement apparatus;
a measurement noise signal being estimated based on the measurement signal;
a first variance estimation and a second variance estimation different from the first variance estimation being performed based on the measurement noise signal, wherein the first variance estimation yields a first variance estimated value and the second variance estimation yields a second variance estimated value;
a final variance estimated value being determined based on a comparison of the first variance estimated value with the second variance estimated value; and
a confidence interval being determined based on the final variance estimated value, wherein the confidence interval is output.

17. The method according to claim 16,
wherein the final variance estimated value is set to the first variance estimated value or the second variance estimated value.

18. The method according to claim 16,
wherein the first variance estimation takes place based on a plurality of samples of the measurement noise signal, wherein fewer samples are used for the first variance estimation than for the second variance estimation.

19. The method according to claim 16,
wherein the first variance estimation takes place based on fewer than 20, fewer than 10, or fewer than 5 samples of the measurement noise signal.

20. The method according to claim 16,
wherein the second variance estimation takes place based on more than 20, 50 or 100 samples of the measurement noise signal.

21. The method according to claim 16,
wherein the final variance estimated value is set to the highest value of the N last samples of the measurement noise signal.

22. The method according to claim 16,
wherein the confidence interval and/or the final variance estimated value is/are further limited based on a process model.

23. The method according to claim 18,
wherein the final variance estimated value is determined based on a plausibility check, wherein the plausibility check comprises that:
the final variance estimated value is set to the second variance estimated value;
when it is determined that a current value of the measurement noise signal is greater than a predefined threshold value, the first variance estimated value is compared to the second variance estimated value; and
when it is determined that the first variance estimated value is larger in amount than the second variance estimated value, the final variance estimated value is set to the first variance estimated value.

24. The method according to claim 23,
wherein the threshold value is determined depending on the final variance estimation.

25. The method according to claim 18,
wherein the final variance estimated value is determined based on a weighting of the first and second variance estimated value, wherein the weighting is determined in dependence on which of the first and second variance estimated value is larger in amount.

26. The method according to claim 16,
wherein the estimation of the measurement noise signal comprises estimating a useful signal associated with the measurement signal and determining the estimated measurement noise signal based on the measurement signal and the estimated useful signal.

27. The method according to claim 16,
wherein the useful signal is estimated based on a polynomial regression and/or based on a prediction filter.

28. The method according to claim 16,
wherein the first variance estimation is performed using a nonlinear FIR filter.

29. The method according to claim 16,
wherein the second variance estimation is performed using a recursive filter.

30. A position measurement apparatus comprising:
a sensor for generating a measurement signal; and
an estimation module that is configured:
to estimate a measurement noise signal based on the measurement signal;
to perform a first variance estimation and a second variance estimation different from the first variance estimation based on the measurement noise signal, wherein the first variance estimation yields a first variance estimated value and the second variance estimation yields a second variance estimated value;
to determine a final variance estimated value based on a comparison of the first variance estimated value with the second variance estimated value; and
to determine a confidence interval based on the final variance estimated value, wherein the confidence interval is output by the estimation module.

31. The position measurement apparatus according to claim 30 that is configured to control an industrial process.

32. The position measurement apparatus according to claim 30, wherein the confidence interval is output by the estimation module and is used in a safety function.

33. The position measurement apparatus according to claim 31, wherein the confidence interval is output by the estimation module to control the industrial process.

34. The method according to claim 16, wherein the confidence interval is output and is used in a safety function.

35. The method according to claim 17,
wherein the final variance estimated value is set to the one of the first or the second variance estimated value that is larger in amount.

36. The method according to claim 24,
wherein the predefined threshold value is set to a multiple of the square root of the final variance estimated value.
